(19) United States
(12) Patent Application Publication
(10) Pub. No.: US 2023/0174319 A1
(43) Pub. Date: Jun. 8, 2023

(54) AUTOMATIC SYSTEM FOR PRODUCING READY-TO-EAT CULINARY PRODUCTS

(71) Applicant: Igor Sergeevich LERNER, Yaroslavl (RU)

(72) Inventor: Igor Sergeevich LERNER, Yaroslavl (RU)

(21) Appl. No.: 17/923,987

(22) PCT Filed: Aug. 5, 2021
(86) PCT No.: PCT/RU2021/000336

§ 371 Date: Nov. 8, 2022

(30) Foreign Application Priority Data
Aug. 20, 2020 (RU) 2020127794

(51) Int. Cl. B65G 47/42; A21C 9/04; A21C 9/08; A21C 15/04

(52) U.S. Cl. CPC B65G 47/42; A21C 9/04; A21C 9/08; A21C 15/04; B65G 2203/041; B65G 2203/0258

(57) ABSTRACT

The invention relates to the field of technologically advanced, automated, fully integrated equipment for producing and packaging convenience food products. The system has a first transport device for food bases, above which a primary food processing subsystem is mounted, consisting of a cooler with equipment making it possible to extract and feed food bases onto the first transport device, and of a group of food distribution units, each of which is configured in the form of a container for food ingredients with a device for processing same, an oven equipped with a second transport device for the food bases, in the area of the input of which a means for transferring the partially ready product is provided, and in the area of the output of which there is a working section equipped with an element for transferring the baked product produced to a packaging subsystem

### FIELD OF THE INVENTION

The present invention relates to the field of technologically advanced, automatic, fully integrated equipment for producing and packaging instant food products, namely, ready-to-eat flour culinary products which are mainly round and relatively close in shape, such as pizza, tortillas, pancakes, shawarma, sandwiches, pies, burritos, hamburgers, etc.

### BACKGROUND OF THE INVENTION

The prior art discloses an arrangement for preparing baked food products (see [1]: SU 406326, IPC A21C 5/00, published Nov. 5, 1973).

This arrangement relates to equipment for the food industry, namely to arrangements for preparing pizza-type dough products.

According to [1], the arrangement for preparing baked food products as pizza-type dough products comprises a means for storing dough pieces, a device for feeding (sampling) the dough pieces and a horizontal conveyor having an endless belt for receiving and transferring the dough pieces. The horizontal conveyor is powered by an electric motor. There are containers for supplying food additives above the horizontal conveyor, after which, in the direction of the endless belt of the horizontal conveyor, an oven is provided for baking culinary products from dough entering the oven.

In the arrangement disclosed in [1], the means for storing the dough pieces is configured as a container for a single dough mass, and the device for feeding (sampling) dough is installed on a suspension bracket and configured to perform batchwise sampling of the dough and uniformly distribute the dough on rotary working sections located on the endless belt and having a certain size and shape. The subsequent molding of the dough pieces to a preferably flat shape is performed by means of a special device configured as a lever having a disk driven by a flywheel.

Except for the conveyor provided with the endless belt and powered by the electric motor, most of the remaining devices and subsystems of the arrangement disclosed in [1] operate in a mechanical mode (i.e., a dough storage container, the device for feeding the dough pieces, a device for molding the dough pieces, etc.), and, thus, require several process operators to be constantly involved in the whole work. This primarily affects the quality of production work since the combination of manual labor of a person and the system served by him/her with the peculiarity of working at a fast pace is certainly associated with the manifestation of errors and inaccuracies in work, as well as secondarily affects the speed of work and, accordingly, the volume of production since it is impossible to ensure a continuous cycle of operation of the arrangement due to the need to change personnel, replenish the containers with dough and food additives, as well as the need to periodically repair and maintain the mechanisms used, which generally characterizes the arrangement as a system having an incomplete automation cycle, low manufacturability and, consequently, low technical and operational capabilities.

The following should also be recognized as additional and significant drawbacks of the arrangement disclosed in [1]: the unforeseen possibility of organizing temporary storage of finished baked products in a stably heated state, as well as the impossibility of packaging the products in an orderly and consistent manner, which limits the functionality of the system and makes it difficult to sell the products effectively and rationally.

The prior art discloses a system for the personalized production of food products (see [2]: EP 3220743, IPC A21C 15/00, published Dec. 12, 2018).

The technical solution known from [2] is an automatic system for the production of flour culinary products (pizza, focaccia bread, etc.) on an individual order.

This system for the personalized production of flour food products, mainly pizza, comprises a section for storing and preparing dough portions, a conveyor subsystem having an endless belt along which the dough portions move, a section for filling the dough portions with ingredients, a section for exposing the dough portions to heat treatment, and a section for storing and delivering the resulting products to a buyer. Said devices are controlled and operated by a central computer, and the initial personalized selection of the resulting products with their features and characteristics is possible directly using a product type selection section on which a user interface is installed.

The system disclosed in [2] is characterized by the presence of a subsystem for identifying dough portions and/or food products associated with a specific buyer, as well as the possibility for the buyer to independently control the user interface of the product type selection section and, thus, select the food product himself/herself by setting the parameters for its preparation and determining the amount of necessary ingredients applied both before and after baking.

The undeniable advantage of the system disclosed in [2] is the possibility for the buyer to independently control almost all food production stages, as well as the possibility for him/her to visually inspect the movement of the food product being prepared and access it at some food production stages, which increases consumer attractiveness and generally has a beneficial effect on the quality and compliance of the selected food product. At the same time, with such a design, one cannot exclude the likelihood of accidental or deliberate contact of food products with foreign objects, which, in the absence of modern quality control tools, can lead to extremely undesirable consequences.

To the noticeable drawbacks of the system disclosed in [2], one can also attribute a rather complex and non-standard scheme for distributing the interconnected numerous equipment of the system with separately installed subsystems, which will require high operating costs for the installation, configuration and periodic software and hardware maintenance of the subsystems.

The prior art discloses an automated system for making pizza (see [3]: WO 19224799, IPC A21C 15/04, published Nov. 28, 2019).

The system disclosed in [3] relates generally to food manufacturing equipment, and more particularly to an automated pizza preparation device that includes robotic subsystems and automated issuing devices for preparing customized and made-to-order pizzas.

The automated system disclosed in [3] is designed for preparing and packaging pizzas and comprises a subsystem for moving dough pieces, above which a food processing subsystem is installed. The food processing subsystem comprises a device for placing the dough pieces on the movement subsystem and a group of food distribution units arranged in series. Each of the units is configured as a container for storing food ingredients, which is provided with a device for processing the food ingredients to provide their estimated delivery to a corresponding product blank. The system further comprises an oven installation equipped with a conveyor, at the input of which a mechanism for transferring a partially finished pizza is equipped, and at the output of which a working section for obtaining a finished pizza is equipped. The working section is equipped with a means of cutting the finished pizza into portions. The working section sends the finished product to a packaging subsystem connected to a subsystem for storing and issuing the finished and packaged product which supplies the necessary product to an automatically opening window. In addition, there is a control unit connected to all the nodes and subsystems with the ability to control and set their operation modes.

The system disclosed in [3] is fully automated, equipped with a transparent protective showcase for viewing the production process and allows one to place an order through a smartphone or tablet mobile application. However, in order to obtain finished products of proper quality, systems of this type need the possibility of automated continuous quality control, which ensures the detection of products that do not meet certain product-specific requirements and their machine extraction for the purpose of revision or disposal. Due to the absence of the above-mentioned possibility as such, there are certain risks of obtaining low-quality, and possibly hazardous to health, products that come directly to a consumer.

It should be noted that if low-quality products are detected when visually inspecting the production cycles, it is possible to remove such products from the system disclosed in [3] only by stopping the operation of the conveyor, which will adversely affect the subsequent production process and require additional quality control of the prepared products from the personnel.

Additionally, it is important to note that the above-mentioned subsystem for moving the dough pieces is an electric conveyor, which, due to its specifics, is programmed for movement with alternating stops and starts, which subsequently, during intensive use, can lead to inaccuracies in the positioning of the conveyor belt, which in turn will lead to malfunctions and require technical intervention to eliminate the malfunctions. Furthermore, since the use of conveyors in any systems requires increased energy resources and is inevitably associated with scheduled maintenance activities, it can be assumed that the maintenance of the system disclosed in [3] is difficult, and its productivity is low.

### SUMMARY OF THE INVENTION

The technical problem solved by the present invention is to create a universal and fully integrated system for producing and packaging ready-to-eat flour culinary products, which operates in automatic mode and has a wide range of functionalities and high technical and operational performance.

The technical result of the present invention, which objectively manifests itself when using the invention, is the implementation of the purpose of creating the technologically advanced, automatic, and fully integrated system which may be programmed to select a desired food product from an available wide range and to determine its composition and characteristics of the preparation taking place under controlled conditions with increased safety and improved quality in terms of compliance with the generally accepted characteristics of resulting food products.

The above-indicated technical result, which solves the above-indicated technical problem, is achieved due to the fact that the automatic system comprises a first transport device for food bases, above which a food processing subsystem is mounted. The food processing subsystem comprises a cooler having equipment configured to withdraw and feed the food bases onto the first transport device, as well as a group of food distribution units each configured as a container for food ingredients with a device for processing the food ingredients. The device for processing the food ingredients is configured to deliver a prescribed amount of the food ingredients onto a corresponding food base. The system further comprises an oven equipped with a second transport device for the food bases. The oven has an input in vicinity of which there is a means for transferring a partially ready food product, as well as an output in vicinity of which there is a working section equipped with an element for transferring a resulting baked food product to a packaging subsystem which is connected to a subsystem for temporarily storing and issuing a ready and packaged food product. The subsystem for temporarily storing and issuing the ready and packaged food product delivers a food product selected by a user to an automatically opening area. Furthermore, digital product quality monitoring tools are installed at outputs of the first and second transport devices. Images of the food product are transmitted to a control computer coupled to a central server and connected to an Internet network. By controlling the functionality and operation modes of the equipment in an integrated manner, the control computer analyzes the received images, comparing them with loaded reference images, and in case of an unsatisfactory result, generates and sends a command signal for low-quality product withdrawal, which is implemented through actuators.

According to one of the most preferred embodiments of the present invention, the first transport device is implemented as a movable two-axis worktable mounted on guides.

According to one of the best embodiments, the two-axis worktable comprises a base having a movable platform installed thereon, the movable platform having a lower part configured to move in a longitudinal direction and an upper part configured to move in a transverse direction.

According to one of the most rational embodiments, the two-axis worktable is equipped with a digital product quality monitoring tool which is implemented as a photo and/or video camera.

According to one of the most preferred embodiments of the present invention, the control computer is configured to: analyze the received images from the product quality monitoring tool installed on the two-axis worktable mainly in combination with the received images from a product quality monitoring tool installed on an exit section of the two-axis worktable; generates, in case of incomplete reference compliance of the products, programmed command signals that activate desired operation modes of the equipment which are aimed at eliminating deficiencies of the products.

According to one of the possible, but not preferred embodiments of the present invention, the first transport device is implemented as a conveyor device having an endless belt.

According to the best embodiment of the present invention, the cooler is a refrigerating chamber for storing the food bases, which is structurally docked with the first transport device.

It is expedient and preferred if the containers for the food ingredients are installed sequentially in a row and comprise free-flowing, pasty, solid, semi-solid and liquid additives.

According to one of the embodiments of the present invention, the second transport device is implemented as a conveyor device having an endless belt.

As a rule, in the present invention, photo and/or video cameras are used as the quality monitoring tools.

According to one of the promising embodiments of the present invention, its working section is equipped with a checkweigher that is configured to measure a weight of the product, and data on the weight are used by the control computer when analyzing the images. If the weight deviates from loaded required indicators, a decision is made to withdraw the low-quality products.

It is preferable when the working section of the system is equipped with a press-mechanism for cutting the baked products.

To provide the greatest advertising success and high attractiveness of the present invention, it is preferable that the main production equipment be operatively combined for visual inspection and covered with a transparent protective showcase.

According to one of the best embodiments of the present invention, the actuators of the system are arranged within transfer sections of the transport devices and are implemented as separate controllable modules equipped with a piston-pusher having a stop and configured to transfer the low-quality products to a storage.

However, the actuators may also be arranged on movable parts of the transport devices and represent separate controllable units configured as a piston-pusher having a stop and configured to transfer the low-quality products to the storage.

According to the inventive concept, the essence of the subject-matter to be patented is to create the stationary and technologically advanced food system that automatically creates mainly ready-to-eat flour culinary products cooked cyclically using the operatively interconnected equipment which, depending on its purpose, performs certain technological operations.

According to the intended design content, the main basic subsystems of the system that determine the purpose and capabilities of the system are represented by the customizable transport devices configured to move the products, as well as a set of food equipment comprising the group of food distribution units, the conveyor oven and the systems for packaging and issuing the resulting products, which are managed and controlled by a computer system programmed to receive and process digital information signals about the selection of certain products and the modes of their preparation and, accordingly, send, to the control units, signals that activate a pre-installed software functionality for a full production cycle of the selected products.

As noted earlier, the automatic system for producing and packaging the ready-to-eat flour products is quite technologically advanced and operates in an automatic programmed mode, which is ensured by its design which implies that the food processing subsystem is installed in vicinity of the first transport device and comprises the cooler with the equipment configured to withdraw and feed the food bases to said transport device, as well as the group of food distribution units that implement the estimated delivery of the required ingredients to the food bases, which are subsequently baked in the oven and fed to the packaging subsystem first and then to the issuing subsystem. The resulting products are withdrawn by a customer from the issuing subsystem through the automatically opening window. The above-listed equipment is also interfaced with each other by automatic loading and unloading means configured for certain operation modes and operates according to the cycle predetermined by the computer system, considering the desired cooking features specified by the customer.

According to the inventive concept, the computer system comprehensively manages the functionality and capabilities (modes) of the automatic system, which, among other things, imply the receipt and subsequent command processing of the corresponding data on the selection of the desired product, its type, as well as cooking modes and features that can be received on place (locally), i.e., generated by the customer directly in the system independently or through an operator, as well as remotely using computer devices via the Internet with the possibility of using a mobile application and indicating an optional delivery address.

It is important to note that the main production cycles (ingredient formation and baking) are controlled by the digital quality monitoring tools, which, in a given automatic mode, produce continuous photo/video shooting of both partially finished products and fully finished products, send images/video images to the computer system in which they are processed by comparison with the reference ones (previously loaded into the system) and, in case of suspicion of a quality discrepancy, the actuators immediately receive a control signal about the withdrawal and disposal of the products. This in fact significantly increases the safety of the products since any foreign objects are prevented from contacting with the products, as well as significantly improve the quality of the products in terms of compliance with the generally accepted standards, in particular, in terms of volume, filling and appearance of instant flour culinary products.

Thus, the above implementation of the automatic system for producing and packaging the ready-to-eat flour products, taking into account its characteristics and technical features, forms a set of features sufficient to achieve the above-indicated technical result, which consists in implementing the purpose of creating the technically advanced, automatic, and fully integrated system which is programmed to: select a desired product from an available wide range; determine its composition and features of its preparation taking place under controlled conditions with increased safety and improved quality in relation to compliance with the generally accepted characteristics of the resulting food products; and solve the existing technical problem of creating the universal and fully integrated system for producing and packaging the ready-to-eat flour culinary products, which operates in automatic mode and has a wide range of functionalities and high technical and operational performance.

### BRIEF DESCRIPTION OF THE DRAWINGS

FIG. 1 shows a schematic diagram of an automatic system for producing and packaging flour culinary products;

FIG. 2 shows an embodiment of a cooler having equipment for placing product bases on a first transport device;

FIG. 3 shows a possible embodiment of an applicable two-axis worktable;

FIG. 4 shows an embodiment in which a group of food distribution units is arranged sequentially above the transport device;

FIG. 5 shows a constructive embodiment of a subsystem for storing and issuing a finished and packaged food product;

FIG. 6 shows a container for solid or semi-solid food ingredients and a device for issuing them in the form of a dispenser having a grater;

FIG. 7 shows a container for solid or semi-solid food ingredients and a device for issuing them in the form of a dispenser having knives;

FIG. 8 shows a container for liquid food ingredients and a device for issuing them in the form of a dispenser having a peristaltic pump;

FIG. 9 shows a container for free-flowing food ingredients and a device for issuing them in the form of a dispenser which is a cone crusher.

### DETAILED DESCRIPTION OF THE INVENTION

The present invention is illustrated by a specific example of its execution and implementation, which, however, is not the only possible, but clearly demonstrates the achievement of the above-indicated technical result by the specified set of essential features, as well as the solution of the existing technical problem.

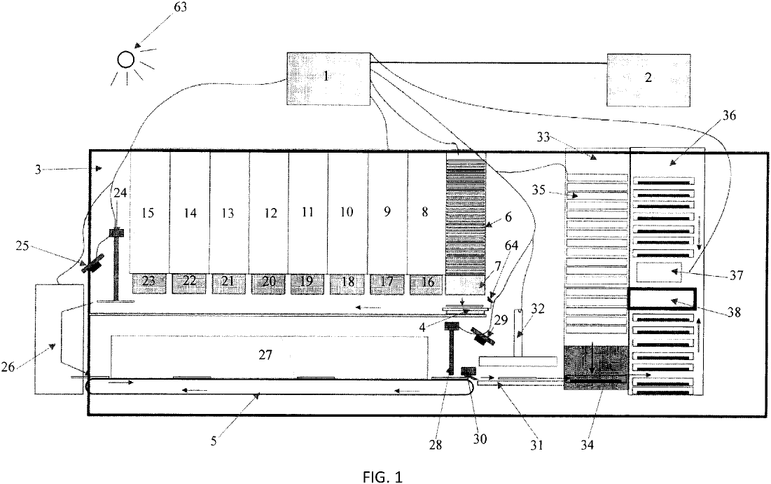

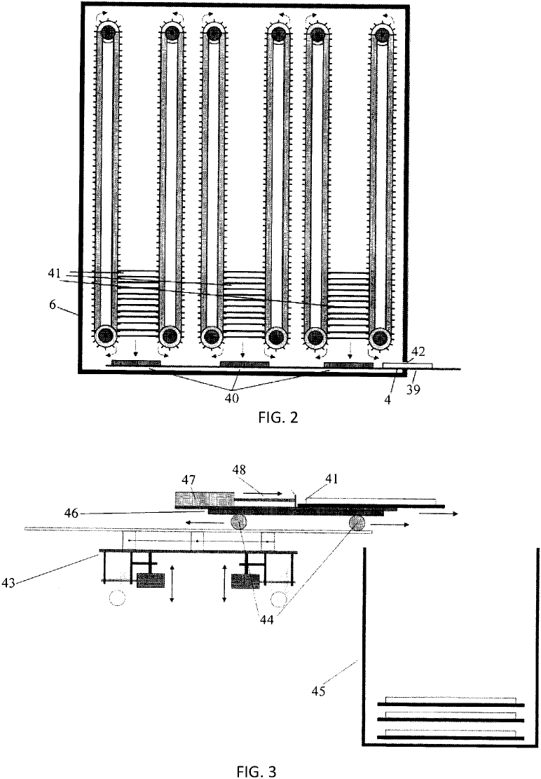

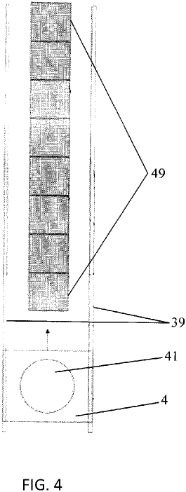

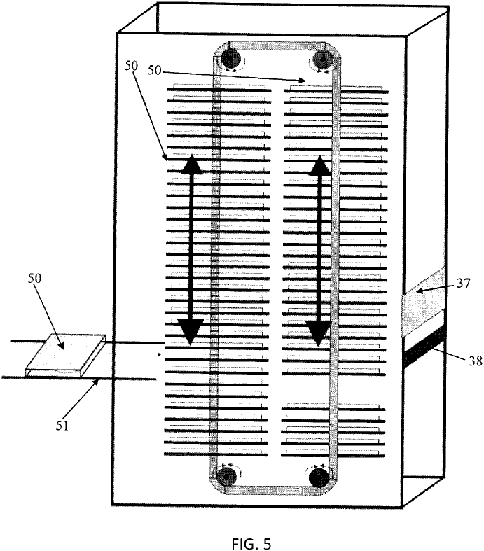

FIGS. 1-9 show the following parts and elements of the automatic system for producing and packaging ready-to-eat flour culinary products:
1 - control computer;
2 - central server;
3 - transparent showcase;
4 - two-axis worktable;
5 - electric conveyor having an endless belt;
6 - refrigerating chamber;
7 - device for withdrawing and feeding product bases to the two-axis worktable;
8 - first container for food ingredients;
9 - second container for food ingredients;
10 - third container for food ingredients;
11 - fourth container for food ingredients;
12 - fifth container for food ingredients;
13 - sixth container for food ingredients;
14 - seventh container for food ingredients;
15 - eighth container for food ingredients;
16 - first device for processing and issuing food ingredients;
17 - second device for processing and issuing food ingredients;
18 - third device for processing and issuing food ingredients;
19 - fourth device for processing and issuing food ingredients;
20 - fifth device for processing and issuing food ingredients;
21 - sixth device for processing and issuing food ingredients;
22 - seventh device for processing and issuing food ingredients;
23 - eighth device for processing and issuing food ingredients;
24 - actuator for withdrawing a thermally untreated product of inadequate quality;
25 - first video camera;
26 - means for transferring a partially finished product;
27 - conveyor oven;
28 - actuator for withdrawing a thermally treated product of inadequate quality;
29 - second video camera;
30 - element for transferring a resulting baked product to a packaging subsystem;
31 - working section;
32 - press-mechanism for cutting products;
33 - packaging subsystem;
34 - mechanism for packaging products;
35 - empty packages;
36 - subsystem for storing and issuing a finished and packaged product;
37 - touchscreen;
38 - window for issuing the finished and packaged product;
39 - guides of the two-axis worktable;
40 - stopping portions of the two-axis worktable in the refrigerating chamber;
41 - blanks of food bases;
42 - technological opening of the refrigerating chamber;
43 - basis of the two-axis worktable;
44 - servo drives;
45 - storage for recycled products;
46 - platform;
47 - pusher;
48 - piston;
49 - group of food distribution units;
50 - packaged products;
51 - movable feed element;
52 - body;
53 - food ingredient;
54 - chopper;
55 - chopper clamps;
56 - chopper motor and drive;
57 - plates with knives;
58 - clamps of the plates with knives;
59 - motor and drive of the plate with knives;
60 - peristaltic pump;
61 - motor and drive of a cone crusher;
62 - cone crusher;
63 - ultraviolet lamps;
64 - third video camera.

The automatic system for producing and packaging the ready-to-eat flour products comprises a first transport device which is implemented as a two-axis worktable 4 and configured to move food bases.

In vicinity of the two-axis worktable 4, or rather above it, there is a food processing subsystem comprising a cooler implemented as a refrigerating chamber 6 with equipment including a device 7 for withdrawing and feeding the food bases to the two-axis worktable 4. Furthermore, the food processing subsystem comprises a group 49 of food distribution units implemented as containers 8-15 for food ingredients with associated devices 16-23 for processing the food ingredients, which ensures the estimated delivery of the food ingredients to the corresponding food bases.

The number of the containers 8-15 may be either less or more than that in the figures. The containers 8-15 in this example are arranged sequentially in one row; however, they may be arranged in several rows, arranged in a circle, arranged one above the other, and any other arrangements are possible that allow effective application of the food ingredients.

The system comprises a furnace installation in the form of a conveyor oven 27 which may be electric, gas, microwave, and any other oven capable of baking the contents.

The conveyor oven 27 is equipped with a second transport device implemented as an electric conveyor 5 having an endless belt for the food bases.

In vicinity of the input of the conveyor oven 27, a means 26 for transferring a partially finished product is equipped, while in vicinity of the output of the conveyor oven there is a working section 31 equipped with an element 30 for transferring the resulting baked product to a packaging subsystem 33 which is operatively connected to a subsystem 36 for temporarily storing and issuing a finished and packaged product 50. The subsystem 36 is configured to feed the product selected by a customer to an automatically opening area in the form of a window 38 from which it may be picked up.

A first video camera 25 and a second video camera 29 are installed, respectively, at the outputs of the two-axis worktable 4 and the electric conveyor 5 with the endless belt, and monitor the quality of the products, in particular, by continuously photographing the products and sending images to a control computer 1 coupled to a central server 2 and connected to the Internet network. The control computer 1 comprehensively manages the functionality and modes/features of the equipment, analyzes the received images by comparing them with pre-loaded reference images of products and, in case of an unsatisfactory result, generates and sends a command signal to withdraw low-quality products, which is executed by actuators 24 and 28. The element 24 is configured to withdraw a thermally untreated product of inadequate quality, while the element 28 is configured to withdraw a thermally treated product of inadequate quality.

The main production equipment of the system may be arranged longitudinally in one row or may be arranged horizontally one under the other or sideways relative to each other, or may be arranged in the form of several rows of randomly located systems on the same level. Any other options for arranging the equipment that do not go out beyond the scope of the presented claims are also possible.

In the embodiment under consideration, the main production equipment of the automatic system for producing and packaging the flour culinary products is operatively combined for visual inspection and protected by a transparent showcase 3.

The automatic system for producing and packaging the ready-to-eat flour products may be implemented as follows.

It should be noted that the purpose of the following description of the present invention is not to limit it to a specific implementation and embodiment, but rather to cover all possible additions that do not go beyond the scope of the appended claims.

The production processes are controlled by the control computer 1 which is a separate element of the system. It is coupled to the central server 2 and connected to the Internet network or a similar data network. Each of the control computer 1 and on the central server 2 has software for transmitting information about incoming orders and about the operation of the system equipment.

It is possible to order a certain flour culinary product (pizza, tortilla, pancakes, cakes, burrito, sandwich, shawarma, pies, hamburgers, etc.), as well as select, if desired, its filling and cooking features by using a software application of any electronic device (smartphone, tablet, electronic bracelet, computer, laptop, etc.) either though at a manufacturer’s website or directly using a touchscreen 37. As a rule, this order represents electronic information about the product type (pizza, tortilla, burrito, pancakes, sandwich, shawarma, pies, hamburgers, etc.) and its form, filling and other features, such as baking time, time by which the product must be ready, etc. Having received the electronic signal, the control computer 1 installed directly in the system processes it through a software algorithm, and forms and subsequently controls a certain operation mode of the system equipment to prepare a specific ordered product (pizza, tortilla, burrito, pancakes, sandwich, shawarma, pies, hamburgers, etc.). At the same time, the database of the central server 2 comprises all possible programs for preparing various flour culinary products (pizza, burrito, tortilla, pancakes, sandwich, shawarma, pies, hamburgers, etc.), as well as algorithms for selecting blanks 41 of food bases, feeding food ingredients 53, selecting preparation modes and features and options for cutting products and their packaging.

The proposed system uses already pre-cooked frozen food bases made as rolled dough pieces of various shapes and sizes, which are laid on a solid substrate, thereby forming the blank 41 of food bases. It is important to note that the frozen food bases may be presented in the form of ready-made pita bread, pieces of sliced bread, rolls and other options.

The food bases with a certain periodicity are placed in the refrigerating chamber 6 on solid substrates, thereby forming the blanks 41 of food bases, which will later be used when producing the products.

Each blank 41 is identified by an operator of the automatic system with a certain shelf in the refrigerating chamber 6 and registered into the database of the central server 2.

After the central server 2 receives information about the order of a certain product, the control computer 1 generates, by means of a software algorithm, a command for the device 7 for withdrawing and feeding the food bases to the two-axis worktable 4. Said device 7 is implemented as groups of double vertically oriented conveyor-type mechanisms which hold the food bases on the substrates (blanks 41) with the help of jumpers installed on belts. The controlled movement of the belts ensures that the blanks are separated and stacked in a required place on the two-axis worktable 4. The device 7 itself delivers the blank 41, which the software, having identified with the order, selects as necessary for the preparation of the product (e.g., pizza, flatbread, sandwich, shawarma, burrito, pies, hamburgers), to the stopping portions 40 of the two-axis worktable 4 which is periodically moved along the guides 39 to the refrigerating chamber 6 through its technological opening 42. This operation becomes possible since the central server 2 stores the coordinates and numbers of conditional shelves with all types and kinds of the blanks 41 of the food bases loaded into the refrigerating chamber 6.

Separately, it is necessary to describe the design of the two-axis worktable 4 used. More specifically, the table comprises a base (baseplate) 43 having a platform 46 installed thereon. The blanks 41 of the food bases are stacked on the platform 46. The platform 46 is configured to move along two guides 39, as in this example, but may move along several guides, with the specified movement being performed back and forth. The platform 46 has an upper part that may move left and right in relation to the guides 39. To move the platform 46, servo drives 44 presented in this example are usually used. To move the platform 46, ball screw servo drives 44 presented in this example are usually used, but other mechanisms can be used, such as encoder-based feedback servo drives, a toothed belt, a pinion-rack/screw-nut pair, a ball screw, a linear drive system with a motor for direct conversion of electromagnetic energy into linear movement, etc. Various mechanisms may also be used as feed drives, such as DC stepper motors, synchronous motors, direct drives, etc.

Under the two-axis worktable 4, according to the proposed invention, one should understand a certain system that combines the bearing structure of a support, an electromechanical drive, a two-axis movement subsystem, an arbitrary-purpose actuator, information-measuring devices and a control system; in addition, the use of other elements is possible. This certain system is essentially intended for precise linear movement of the platform 46 with the blanks 41 of the food bases along two perpendicular axes in the horizontal plane, namely, the movement of the blank 41 arranged on the platform 46 is performed in the directions back-forth and right-left in relation to the guides 39.

After the device 7 for withdrawing and feeding the food bases transfers them to the two-axis worktable 4, the control computer 1 instructs, through the software algorithm, the servo drives 44 of the two-axis worktable 4 to move a certain distance along the guides 39, so that the near edge of the blank 41 of the food base is directly under one of the containers 8-15 for the food ingredients. This operation becomes possible because the two-axis worktable 4 comprises the guides with linear bearings, the ball screw with the servo drive and a revolution counter on the axis of a servomotor.

The following data are pre-entered in the control computer 1: the coordinates of the beginning of the zone of action of each of the containers 8-15 with the devices 16-23 for processing and issuing the food ingredients. Given this, by transmitting a command to the servo drives 44 to move the two-axis worktable 4 forth or back along the guides 39, the control computer 1 delivers the blank 41 to the place necessary for applying the food ingredient.

The containers 8-15 may have various devices 16-23 for issuing the food ingredients in their lower parts.

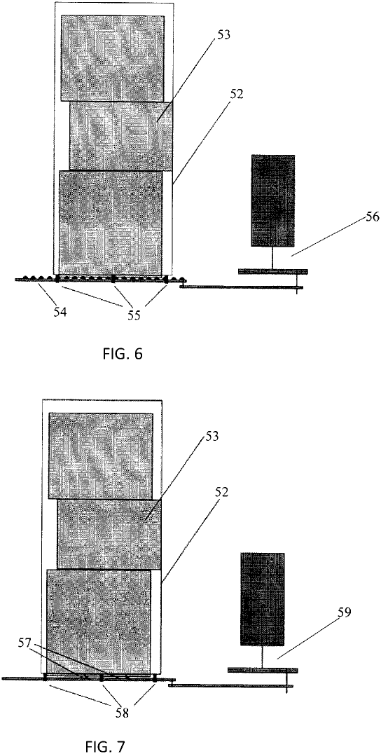

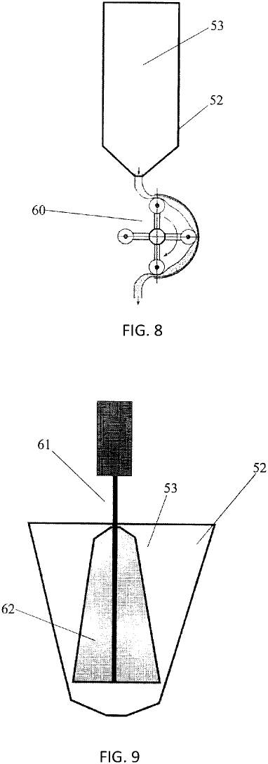

Thus, the container may be intended for solid or semi-solid food ingredients and be equipped with the device for issuing them in the form of a dispenser having a grater (see FIG. 6) or the device for issuing them in the form of a dispenser having knives (see FIG. 7). The container may be intended for liquid ingredients, for which reason it is equipped with the device for issuing them in the form of a peristaltic pump (see FIG. 8). The container may also be intended for free-flowing food ingredients, for which reason it is equipped with a dispenser in the form of a cone crusher (see FIG. 9).

The containers 8-15 may be made of various materials (metal with a special coating, plastic, etc.) that provide long-term storage of the food ingredients. Filling the containers 8-15 with the food ingredients is carried out by the system operator once a day or as they are used up. The containers 8-15 may be equipped with temperature, weight, volume sensors, etc., which are connected to the control computer 1 and transmit a corresponding signal to it in case of deterioration of any parameter or transmit a signal about the sufficiency of applying the food ingredient to the food base.

The devices 16-23 for issuing the food ingredients are also connected to the control computer 1, from which they receive a command as to how much of a certain food ingredient should be applied to a particular blank 41 of food base.

The containers 8-15 are suspended vertically in the system, which allows using the action of gravity to lower the food ingredients, namely, into the area of action of the dispensers. Additionally, the containers 8-15 may be equipped with rollers, as well as other auxiliary means to facilitate the feeding of the food ingredients.

After the two-axis worktable 4 with the blank of the food base stops under the required container 8-15, the signal from the servo drives 44 enters the control computer 1, as a result of which it instructs the device 16-23 of this container to start the process of applying the contained food ingredient.

Out of the advantages of the two-axis worktable 4, it can be noted that the worktable 4 is made with the previously mentioned possibility of moving the platform 46 with the blank 41 of the food base to the left and right in relation to the guides 39 along which the worktable 4 itself moves, thereby allowing one to use the fixed (stationary) containers 8-15 because when applying the food ingredient, the platform 46 itself with the blank 41 moves in 4 directions (back-forth, right-left). With such an arrangement of the two-axis worktable 4, the food ingredients may be applied to the blanks 41 having a food base of any shape; furthermore, they may be applied to halves, quarters and other parts of the food base to cover the entire surface of the food base in a guaranteed and controlled manner. An additional important advantage of the two-axis worktable 4 should be considered the presence of a third video camera 64 whose produced images of the products may be transmitted to the control computer 1 to solve the problem of sending control signals to refine the products when they do not meet the generally accepted standard, information about which is contained in an exhaustive form in the computer system.

Under the platform 46 of the two-axis worktable 4, weight sensors may be installed, which will allow the control computer 1 to be informed, after each operation, about how much of a certain food ingredient applied to this blank of the food base. If the amount does not meet the standard, the controlled computer 1 instructs an appropriate dispenser to continue the cooking process.

After the blank 41 of the food base has been coated with all the necessary food ingredients in the right amount on the two-axis worktable 4, it is picked up by the means 26 for transferring the partially finished product which is implemented as a pusher-piston and rearranges the blank 41 into the conveyor oven 27 where the blank 41 moves along the metal endless belt of the electric conveyor 5 at a given speed and a necessary heat treatment process takes place.

After baking, the blank 41 moves to the working section 31. Then, with the help of the element 30 for transferring the resulting baked product which is implemented as a pusher-piston, the baked food base enters the packaging subsystem 33. Before entering the packaging subsystem 33, the baked product may be divided into parts using a press-mechanism 32 for cutting products. The press-mechanism 32 is provided in vicinity of the working section 31 and is also connected to the control computer 1 and, accordingly, receives necessary control signals from the control computer 1.

When entering the packaging subsystem 33, the baked products are placed in packages 35 by means of a mechanism 34 for packaging products which is implemented as a holder-unit having gripping elements holding the package 35 in its lower part with open lids through which the products enter and are transferred further in packaged form, namely, in the form of the packaged products 50 by means of a movable feeding element 51 to the subsystem for temporarily storing and issuing the finished and packaged product 36.

This subsystem 36 has a heating element configured to maintain the heated state of the finished products and structurally implies the presence of a vertically oriented conveyor-type device which is based on a flexible working body moving in a closed loop with alternating shelves on which the packaged products 50 are placed. By moving up or down, the packaged products 50 are fed into the automatic window 38 based on the command coming from the control computer 1 in accordance with the previously issued order.

If necessary, the packaged products 50 may be stored for a certain amount of time in the subsystem 36 until they are issued to the customer. At the same time, after the products (pizza, tortilla, burrito, sandwich, shawarma, pies, hamburgers, etc.) are cooked, the control computer 1 sends a command to the central server 2 which sends a notification to the client on his/her mobile device, computer, tablet, laptop, or in any other way, including notifying the operator that the product is ready and subject to transfer to a specific customer.

If the order was placed remotely via the Internet network, the received notification comprises a secret code that allows one to identify this customer, whereupon the customer approaches the issuance window 38, enters this code on the touchscreen 37, or brings a mobile device to a subsystem reader and shows a QR code received from the central server 2.

The program installed on the control computer 1 identifies this client and activates the opening of the automatic window 38 which received the product selected earlier in accordance with his/her order. Thus, the client can receive the product ordered by him/her from the outside of the subsystem 36.

In addition, the software of the control computer 1 is configured to track the time of product readiness, which is indicated to the client when confirming the order and notifying the client about the readiness of the order. If preset storage time passes after the notification of the readiness of the order, the order enters the “not selected” status and is subject to disposal during the maintenance of this system by a process operator.

It should be noted that at the output of the two-axis worktable 4, i.e., in vicinity of its end part, the first video camera 25 is installed on a special stand. Furthermore, the two-axis worktable itself comprises the third video camera 64. During the movement of the two-axis worktable 4, the first video camera 25 and possibly the third video camera 64 transmit, to the control computer 1, information about the appearance of the blank 41 of the food base before and after the application of each food ingredient, as well as video monitoring of the absence of foreign and inadmissible objects on the blank 41 is also carried out. If the software of the control computer 1 determines a low quality assessment and shortcomings of the analyzed blank 41 of the food base, for example, the uneven application of the food ingredient, then the control computer 1, having determined this fact, may instruct the two-axis worktable 4 to change the position of the unfinished blank in relation to the desired container 8-15, in order to apply the required amount of the food ingredient. If it is established that an invalid object is on the blank, the control computer 1 immediately instructs the two-axis worktable 4 to move the low-quality blank close to the actuator 24 for withdrawing the thermally untreated product of inadequate quality.

The actuator 24 for withdrawing the thermally untreated product of inadequate quality is arranged within the transfer section of the two-axis worktable 4 and is implemented as a separate installed module equipped with a piston-pusher having a stop and configured to withdraw low-quality products. More specifically, when the two-axis worktable 4 with a dough piece to be withdrawn moves to the actuator 24, then the piston-pusher pushes the blank into a storage 45. As an alternative option for removing a low-quality dough piece, a controlled unit may be used, which is arranged directly on the platform 46, comprises a pusher 47 and a piston 48 with a stop which actually move the low-quality products to the storage 45 on command.

It should be stressed out that the processes of controlling the application of the food ingredients are carried out until all the necessary food ingredients are applied to the blanks 41. If the blank is disposed of without the possibility of its recovery, then the control computer 1 instructs the two-axis worktable 4 to move a desired portion to the area of issuing new blanks and re-execute the entire food ingredient filling process with the same high-quality control.

If the control computer 1 decides that there are no violations in the preparation and layout of the blank and the blank meets all previously laid down standards, a decision is made to move the two-axis worktable 4 with the corresponding blank to the means 26 for transferring the partially finished product to the conveyor oven 27.

It should also be noted that in the exit zone from the conveyor oven 27 in the exit area (end part) of the electric conveyor 5 with the endless belt, the second video camera 29 is installed on a special stand and is also connected to the control computer 1. This camera 29 transmits photo and video images of a baked product (pizza, tortilla, burrito, sandwich, shawarma, pancakes, pies, hamburgers, etc.) to the control computer 1 where the software evaluates the quality of the product. If the quality does not meet the previously laid down and generally accepted standards or foreign objects are found in the baked product, then this baked product is transferred to a storage for products to be disposed of, like the storage 45, by using the actuator 28 for withdrawing the thermally treated product of inadequate quality. The actuator 28 is arranged within the transfer section of the electric conveyor 5 with the endless belt and is implemented as a separate installed module equipped with a piston-pusher having a stop and configured to withdraw low-quality baked products. At the same time, in the case of disposal of the baked product (pizza, tortilla, pies, pancakes, burrito, shawarma, hamburgers, etc.), the control computer 1 sends a command to repeat the preparation process of this product, starting from the process of issuing the blank 41 of the food base from the refrigerating chamber 6 and ending with the re-baking of the food base according to the same order.

Also, the most important thing is that almost all the cooking time, the products are in the coverage area of the first and second video cameras 25 and 29, respectively. Due to this, at almost all production stages of the products, “manual” quality control may also be carried out by the system operator on a monitor, which allows one to stop the system operation in the event of a clear violation.

Regarding the comparison of the received images of the products being prepared with the numerous images of the reference products previously loaded into the control computer 1, it is important to report the following.

The software of the control computer 1 and the central server 2 comprises artificial intelligence elements.

The initially used computer program displays and downloads hundreds of thousands of images of possible products (pizza, tortilla, burrito, shawarma, pies, pancakes, sandwiches, hamburgers, etc.) that meet the generally accepted standards and are reference. The product parameters are evaluated by programmers and the results of the evaluation are reported to the program.

This program is informed about the existing shortcomings of this product by graphically highlighting those elements of the product that do not meet the requirements, for example, an insufficient amount of some food ingredient in a certain area of this product, poor sauce or cheese application, dough defects, a size mismatch, an irregular shape, the presence of foreign objects, etc.

The artificial intelligence of the control computer 1 evaluates the state of the blank 41 of the food base after the technological operation, comparing it with photographs of the reference (generally accepted, corresponding to international quality standards) products present in its database. As already mentioned, in parallel, the control computer 1 may optionally receive data on the weight of the products, which allows one to determine the amount of the applied food ingredient which is compared with the established and previously laid down standard.

These check results are sent to the central server 2 and, if it is found that the blanks do not meet the production quality according to any criteria or contain foreign objects, a signal is immediately generated and sent for withdrawing and disposal of products. In some cases, a signal may be sent to a service operator to stop the operation of the entire system for technical reasons, requiring the personal intervention of maintenance personnel.

An optional (additional) assessment method which will allow software with artificial intelligence elements to improve the quality of analysis and self-learn, involves comparing the received numerous photographs of finished blanks and finished products with consumer ratings, i.e., the consumer ratings regarding a specific product with its photo attached and descriptions of shortcomings made in the software application or at the manufacturer’s website.

Thus, the automatic system is technologically advanced and operates in an automatic mode, which is actually ensured by its design execution which implies that the food processing subsystem is installed in vicinity of the two-axis worktable 4 and comprises the refrigerating chamber 6 with the device 7 for withdrawing and feeding the food bases to the two-axis worktable 4 and the containers 8-15 providing the estimated delivery of the necessary food ingredients to the food bases which are subsequently baked in the conveyor oven 27 and enter the packaging subsystem 33, from which they are entered into the subsystem 36 for storing and issuing the finished and packaged product. From the subsystem 36, the products are removed by the customer through the automatically opening window 38. The above-listed equipment is interfaced with each other by the automatic loading and unloading means (the actuators 24 and 28, the means 26 for transferring the partially finished product, the element 30 for transferring the resulting baked product to the packaging subsystem 30, etc.) and operates according to the cycle predetermined by the computer system, considering the desired cooking features specified by the customer.

Also, the computer system (the control computer 1 and the central server 2) comprehensively manages the functionality and capabilities (modes) of the automatic system, which, in particular, involve the receipt and subsequent command processing of data on the selection of a desired product, its type, as well as its cooking modes and features. The data may come in place (locally), i.e., be generated by the customer directly in the system independently or through the operator, as well as remotely through a mobile application with the possible indication of a delivery address.

Additionally, it should be noted that the main production cycles (food ingredient formation and product baking) are thoroughly and effectively controlled by the video cameras 25 and 29 and optionally by the third camera 64 which, in a given automatic mode, are configured to photograph both partially finished products and fully finished products in a programmatic manner and send images to the computer system where, by means of the software with the artificial intelligence elements, they are processed by comparing with the reference ones (previously loaded into the system). In case of suspicion of a quality discrepancy, the actuators 24 and 28 immediately receive a control signal about the withdrawal and disposal of the products. In special cases, a signal is received about a complete stop of production for technical reasons, which in turn significantly increases the safety of products, since any foreign objects are prevented from contacting with the products, and also certainly increases the quality of the products in terms of compliance with the generally accepted standards, in particular, in terms of the volume, content and appearance of instant flour culinary products.

The system may be equipped with UV lamps 63 which periodically or continuously, depending on their settings, treat the equipment from bacteria.

In the presented embodiment, the main production equipment of the automatic system is operatively combined for visual inspection and is covered with the transparent protective showcase 3.

For security purposes, the system may be limited on all sides by a housing fence comprising a service opening.

The system may be implemented as a stationary vending machine, a system installed on a vehicle or comprising wheels for its movement, or the system may be installed indoors as a stationary retail facility.

The present invention will find wide application in the food service sector as a safe and technologically advanced system for producing instant flour foods.

1. An automatic system for producing and packaging ready-to-eat flour products, comprising:
a first transport device for food bases;
a food processing subsystem mounted above the first transport device, the food processing subsystem comprising:
a cooler having equipment configured to withdraw and feed the food bases onto the first transport device; and
a group of food distribution units each configured as a container for food ingredients with a device for processing the food ingredients, the device for processing the food ingredients being configured to deliver a prescribed amount of the food ingredients onto a corresponding food base;
an oven equipped with a second transport device for the food bases, the oven having an input in vicinity of which there is a means for transferring a partially ready food product and an output in vicinity of which there is a working section equipped with an element for transferring a resulting baked food product to a packaging subsystem, the packaging subsystem being connected to a subsystem for temporarily storing and issuing a ready and packaged food product, the subsystem for temporarily storing and issuing the ready and packaged food product delivering a food product selected by a user to an automatically opening area;
wherein digital product quality monitoring tools are installed at outputs of the first and second transport devices;
wherein images of the food products are transmitted to a control computer coupled to a central server and connected to an Internet network; and
wherein the control computer is configured, by controlling functionalities and operation modes of the equipment in an integrated manner, to analyze the received images, comparing the received images with loaded reference images, and in case of an unsatisfactory result, generate and send a command signal for low-quality product withdrawal, which is executed by actuators.

2. The automatic system of claim 1, wherein the first transport device is implemented as a movable two-axis worktable mounted on guides.

3. The automatic system of claim 2, wherein the two-axis worktable comprises a base having a movable platform installed thereon, the movable platform having a lower part configured to move in a longitudinal direction and an upper part configured to move in a transverse direction.

4. The automatic system of claim 2, wherein the two-axis worktable is equipped with a digital product quality monitoring tool.

5. The automatic system of claim 4, wherein the digital product quality monitoring tool is implemented as a photo and/or video camera.

6. The automatic system of claim 4, wherein the control computer is configured to:
analyze the received images from the product quality monitoring tool installed on the two-axis worktable mainly in combination with the received images from a product quality monitoring tool installed at the output of the two-axis worktable;
generate, in case of incomplete reference compliance of the products, programmed command signals that activate desired operation modes of equipment which are aimed at eliminating deficiencies of the products.

7. The automatic system of claim 1, wherein the first transport device is implemented as a conveyor device having an endless belt.

8. The automatic system of claim 1, wherein the cooler is a refrigerating chamber for storing the food bases which is structurally docked with the first transport device.

9. The automatic system of claim 1, wherein the containers for the food ingredients are installed sequentially in a row and comprise free-flowing, pasty, solid, semi-solid and liquid additives.

10. The automatic system of claim 1, wherein the second transport device is implemented as a conveyor device having an endless belt.

11. The automatic system of claim 1, wherein photo and/or video cameras are used as the quality monitoring tools.

12. The automatic system of claim 1, wherein the working section is equipped with a checkweigher that is configured to measure a weight of the products, and data on the weight are used by the control computer when analyzing the images, and wherein, if the weight deviates from loaded required indicators, a decision is made to withdraw the low-quality products.

13. The automatic system of claim 1, wherein the working section is equipped with a press-mechanism for cutting the backed products.

14. The automatic system of claim 1, wherein the main production equipment is operatively combined for visual inspection and covered with a transparent protective showcase.

15. The automatic system of claim 1, wherein the actuators are arranged within transfer sections of the transport devices and are implemented as separate controllable modules equipped with a piston-pusher having a stop and configured to transfer the low-quality products to a storage.

16. The automatic system of claim 1, wherein the actuators are arranged on movable parts of the transport devices and are separate controllable units configured as a piston-pusher having a stop and configured to transfer the low-quality products to a storage.
